(19) United States
(12) Patent Application Publication
(10) Pub. No.: US 2003/0144851 A1
(43) Pub. Date: Jul. 31, 2003

(54) Method and system for controlling production and exportation

(76) Inventors: Yi-Ming Liao, Taipei (TW); Pei-Huan Chung, Taipei (TW); Cheng-Ju Chen, Taipei (TW); Ching-Ching Chang, Taipei (TW); Wen-Yi Chang, Taipei (TW)

Correspondence Address: ROTHWELL, FIGG, ERNST & MANBECK, P.C., 1425 K STREET, N.W., SUITE 800, WASHINGTON, DC, 20005, US

(21) Appl. No.: 10/055,919

(22) Filed: Jan. 28, 2002

(51) Int. Cl. G06F 17/60

(52) U.S. Cl. 705/1; 705/10

(57) ABSTRACT

A method and a system for controlling production and exportation are proposed, for connecting trading branches of an enterprise to the system for controlling production and exportation via a network, wherein the system for controlling production and exportation shares client orders with the trading branches for product exportation, so as to improve business performances for the trading branches, and enhance profits for the enterprise. In this case, received client order data are processed in a manner as to be transferred suitable trading branches for product manufacture and exportation. This therefore makes products to be cost-effectively manufactured, and provides the business performances for required trading branches, thereby enhancing confidence of investors to the trading branches and increasing overall profits and achievements for the enterprise.

### FIELD OF THE INVENTION

The present invention relates to methods and systems for controlling production and exportation, and more particularly, to a method and a system for controlling production and exportation of products, in which business performances of all trading branches of an enterprise are integrated so as to increase overall profits and achievements.

### BACKGROUND OF INVENTION

In a trend to internationalize an enterprise, multiple trading branches are established in overseas countries, so as to spread and sell products for expanding the enterprise business all around the world.

The trading branches of the enterprise each normally has its own system for managing production and exportation, so as to manufacture and export products corresponding to orders from clients. However, in this case, if a trading branch receives client orders and accordingly exports products, such business performances cannot be effectively shared with other trading branches. On the contrary, if a trading branch lacks profits in no receipt of client orders, this then disappoints a local investor of the trading branch, and makes the local investor lose confidence to the enterprise due to not realizing the actually performances of the enterprise.

Moreover, as costs in product manufacture correspond to resource availability in different areas, with no integration of client orders and management of production and exportation of products from all the trading branches, the enterprise loses opportunity of better profits.

Therefore, how to immediately share business performances and profits to required trading branches for enhancing confidence of investors and further increasing profits for the enterprise, is a critical problem to solve.

### SUMMARY OF THE INVENTION

A primary objective of the present invention is to provide a method and a system for controlling production and exportation, in which individual systems for managing production and exportation of trading branches of an enterprise are integrated, so as to share business performances with all the trading branches, and thus increase profits and achievements for the enterprise.

Another objective of the invention is to provide a method and a system for controlling production and exportation, in which available resources are integrated from various trading branches of an enterprise, so as to assign suitable places for product manufacture and exportation, thereby increasing profits for the enterprise.

In accordance with the foregoing and other objectives, the present invention proposes a method and a system for controlling production and exportation.

The method for controlling production and exportation of the invention is used to connect trading branches of an enterprise to a system for controlling production and exportation via a network, wherein the system for controlling production and exportation shares client orders with the trading branches for product exportation, so as to improve business performances for the trading branches, and enhance profits for the enterprise. The method for controlling production and exportation comprises the steps of; (1) receiving client order data transmitted from a first trading branch via the system for controlling production and exportation, and storing the client order data in an original database of the system for controlling production and exportation, wherein the first trading branch does not perform production and exportation; (2) retrieving the client order data from the original database via the system for controlling production and exportation, and processing the client order data to be first processed order data in a manner that, a material lacking status of the first trading branch is marked in the client order data, a seller is changed from the first trading branch to a second trading branch, and product prices are adjusted to be lower, wherein the first processed order data are stored in a first database; prompting the second trading branch to login the system for controlling production and exportation, and retrieving the first processed order data from the first database according to system authorization provided for the second trading branch via the system for controlling production and exportation, so as to assign the first processed order data to the second trading branch as a business performance thereof, whereas the second trading branch does not perform production and exportation; (3) retrieving the first processed order data from the first database via the system for controlling production and exportation, and processing the first processed order data to second processed order data in a manner that, a material lacking status of the second trading branch is marked in the first processed order data, a seller is changed from the second trading branch to a third trading branch, and the product prices are adjusted to be further lower, wherein the second processed order data are stored in a second database; prompting the third trading branch to login the system for controlling production and exportation, and retrieving the second processed order data from the second database according to system authorization provided for the third trading branch via the system for controlling production and exportation, so as to assign the second processed order data to the third trading branch as a business performance thereof, and allow the third trading branch to perform product manufacture; (4) exporting manufactured products to the first trading branch via the third trading branch after completing the product manufacture; and (5) retrieving the client order data from the original database via the first trading branch, so as to allow the first trading branch to determine if the manufactured products are complete according to the client order data, wherein if the products are not complete, the third trading branch is informed to accordingly supplement materials.

The system for controlling production and exportation of the invention is connected with trading branches of an enterprise via a network, allowing client orders to be shared with the trading branches for product exportation, so as to improve business performances for the trading branches, and enhance profits for the enterprise. The system for controlling production and exportation comprises: an original database for storing client order data received by a first trading branch; an analyzing module for generating corresponding reaction according to requests transmitted from the trading branches; a processing module for transferring the client order data from the first trading branch to other trading branches, wherein upon receiving a request for uploading the client order data from the first trading branch, the analyzing module stores the uploaded client order data in the original database according to system authorization provided for the first trading branch, and prompts the processing module to retrieve the client order data from the original database, so as to process the client order data to be first processed order data in a manner that, order items of the client order data are reset to be in a material lacking status, product prices are adjusted to be lower than those in the client order data, and a seller is changed from the first trading branch to a second trading branch; wherein subsequently the processing module processes the first processed order data to be second processed order data in a manner that, order items of the first processed order data are reset to be in a material lacking status, product prices are adjusted to be lower than those in the first processed order data, and a seller is changed from the second trading branch to a third trading branch, so as to allow the third trading branch to perform product manufacture and export manufactured products to the first trading branch; a first database for storing the first processed order data to be retrieved by the second trading branch after loginning the system for controlling production and exportation; and a second database for storing the second processed order data to be retrieved by the third trading branch after loginning the system for controlling production and exportation.

In the use of the method and system for controlling production and exportation of the invention, trading branches of an enterprise are integrated in a manner as to transfer client orders to suitable trading branches for product manufacture and exportation, so that profits are raised for the enterprise, and business performances and achievements are improved for all the trading branches.

### BRIEF DESCRIPTION OF THE DRAWINGS

The present invention can be more fully understood by reading the following detailed description of the preferred embodiments, with reference made to the accompanying drawings wherein:

FIG. 1 is a schematic block diagram showing basic architecture of a preferred embodiment of a system for controlling production and exportation of the invention; and

FIGS. 2(A) and 2(B) are schematic diagrams depicting a preferred embodiment of a method for controlling production and exportation of the invention.

### DETAILED DESCRIPTION OF THE PREFERRED EMBODIMENT

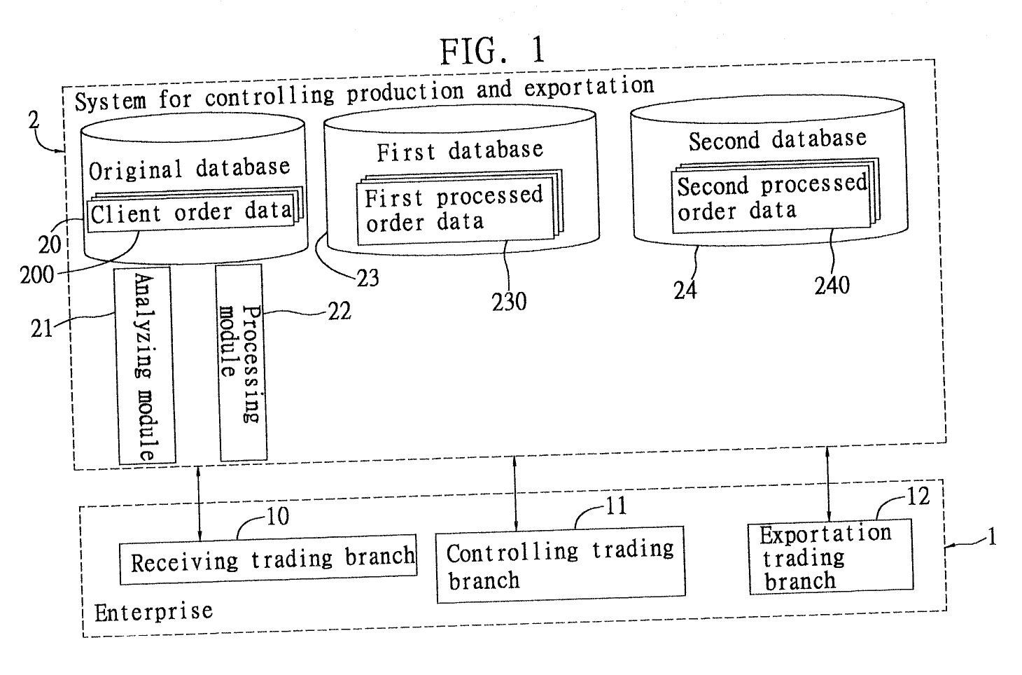

Referring to FIG. 1, it illustrates basic architecture of a system for controlling production and exportation 2 of the invention. As shown in the drawing, trading branches located around the world of an enterprise 1 are connected to the system for controlling production and exportation 2 by a network communication system (not shown) such as internet or intranet; that is, in the use of the system for controlling production and exportation 2, the enterprise 1 is capable of controlling operation of production and exportation in the trading branches. For the sake of enterprise internal security, first, the system for controlling production and exportation 2 asks a user to input a user's name and password prior to being loginned, and then provides the user with authorization of data retrieval and system operation according to the inputted user's name and password. Since such an identification procedure is essential for loginning a system via a network, and is well known for a person familiar with network technology, thus it is not further described in detail, but only associated part relating to the invention is depicted herein.

In this embodiment, the enterprise 1 comprises a receiving trading branch 10, a controlling trading branch 11 and an exportation trading branch 12, and these trading branches are located in different areas. The system for controlling production and exportation 2 comprises an original database 20, an analyzing module 21, a processing module 22, a first database 23 and a second database 24. The system for controlling production and exportation 2 is established in a server host, for allowing the trading branches of the enterprise 1 to transmit and interact with the server host so as to retrieve data stored in the server host.

The analyzing module 21 accordingly generates reaction corresponding to requests transmitted from the trading branches. Upon receiving a client order, the receiving trading branch 10 logins the system for controlling production and exportation 2, and submits a request for uploading client order data 200, allowing the analyzing module 21 to store the client order data 200 uploaded by the receiving trading branch 10 in the original database 20; at the mean time, the receiving trading branch 10 does not perform production and exportation. The processing module 22 is prompted by the analyzing module 21 to retrieve the client order data 200 from the original database 20, so as to process the retrieved data to be first processed order data 230 in a manner that, order items of the client order data 200 are reset to be in a material lacking status, product prices are adjusted to be lower than those in the client order data 200, and a seller is changed from the receiving trading branch 10 to the controlling trading branch 11, wherein the first processed order data 230 are stored in the first database 23. If the controlling trading branch 11 logins the system for controlling production and exportation 2, and submits a request for downloading client order data, the analyzing module 21 is prompted to retrieve the first processed order data 230 from the first database 23 according to system authorization provided for the controlling trading branch 11, and transmits the retrieved first processed order data 230 to the controlling trading branch 11. This therefore transfers the client order previously received by the receiving trading branch 10 to the controlling trading branch 11, so as to improve business performance for the controlling trading branch 11.

After the controlling trading branch 11 retrieves and analyzes the first processed order data 230 for resource availability, if another trading branch is found to be lower in cost expense for production, the controlling trading branch 11 logins the system for controlling production and exportation 2, and submits a request for altering a location for production and exportation. The processing module 22 is then prompted by the analyzing module 21 to retrieve the first processed order data 230 from the first database 23, and processes the retrieved data to be second processed order data 240 in a manner that, order items of the first processed order data 230 are reset to be in a material lacking status, product prices are adjusted to be lower than those in the first processed order data 230, and a seller is changed from the controlling trading branch 11 to the exportation trading branch 12, wherein the second processed order data 240 are stored in the second database 24. If the exportation trading branch 12 logins the system for controlling production and exportation 2, and submits a request for downloading client order data, the analyzing module 21 is prompted to retrieve the second processed order data 240 from the second database 24 according to system authorization provided for the exportation trading branch 12, and transmit the retrieved second processed order data 240 to the exportation trading branch 12. This therefore transfers the client order previously received by the controlling trading branch 11 to the exportation trading branch 12, allowing the exportation trading branch 12 to perform product manufacture and exportation according to the second processed order data 240. After completing the product manufacture, an exportation message is transmitted to the receiving trading branch 10. In receipt of manufactured products from the exportation trading branch 12, the receiving trading branch 10 logins the system for controlling production and exportation 2, and submits a request for downloading client order data. The analyzing module 21 is prompted to retrieve the client order data 200 from the original database 20 according to system authorization provided for the receiving trading branch 10, and transmit the retrieved data to the receiving trading branch 10, so as to allow the receiving trading branch 10 to determine if the manufactured products from the exportation trading branch 12 are complete according to the client order data 200. As a result, since suitable trading branches are assigned for product manufacture and exportation in response to practical cost expense, thus it can improve profits for the enterprise 1.

In exemplification, if a trading branch (i.e. receiving trading branch 10) located in Europe of an enterprise 1 receives client orders, in order to increase business performance for a main branch (i.e. controlling trading branch 11) and confidence of local investors, the client orders are transferred from the receiving trading branch 10 to the main branch. Subsequently, if the main branch analyzes another trading branch (i.e. exportation trading branch 12) to be lower in production cost, the main branch then transfers the client orders to the trading branch with lower costs for product manufacture. For example, if the main branch is located in Taiwan, with a trading branch established in Mainland China, due to assemblage profits lower in Taiwan than Mainland China, thus client orders received by Taiwan are transferred to Mainland China for product manufacture; this therefore helps improve profits for the enterprise 1.

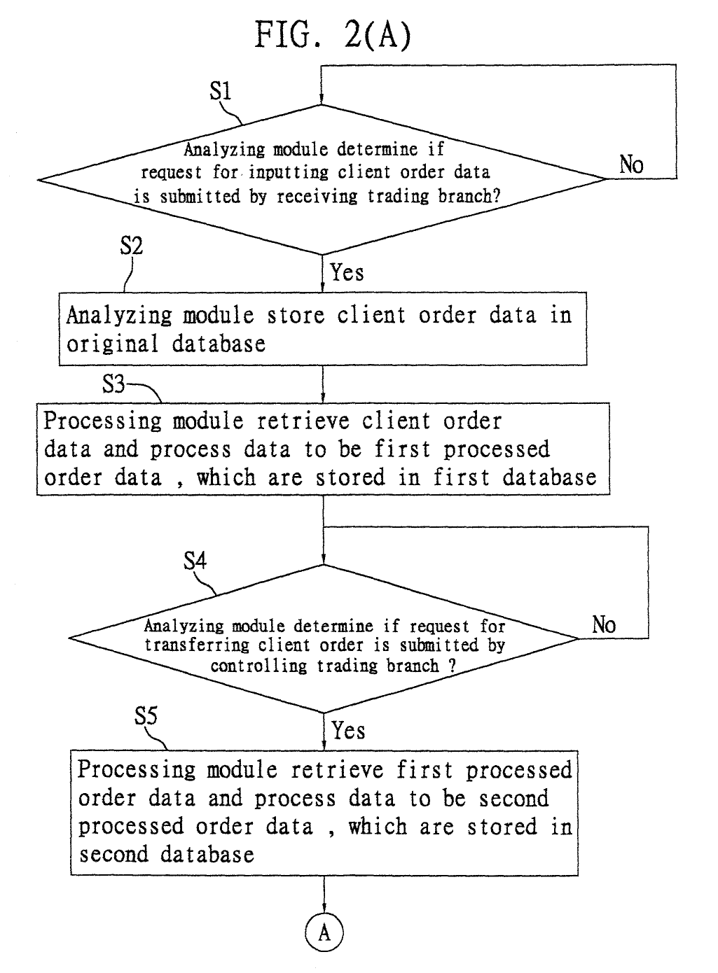

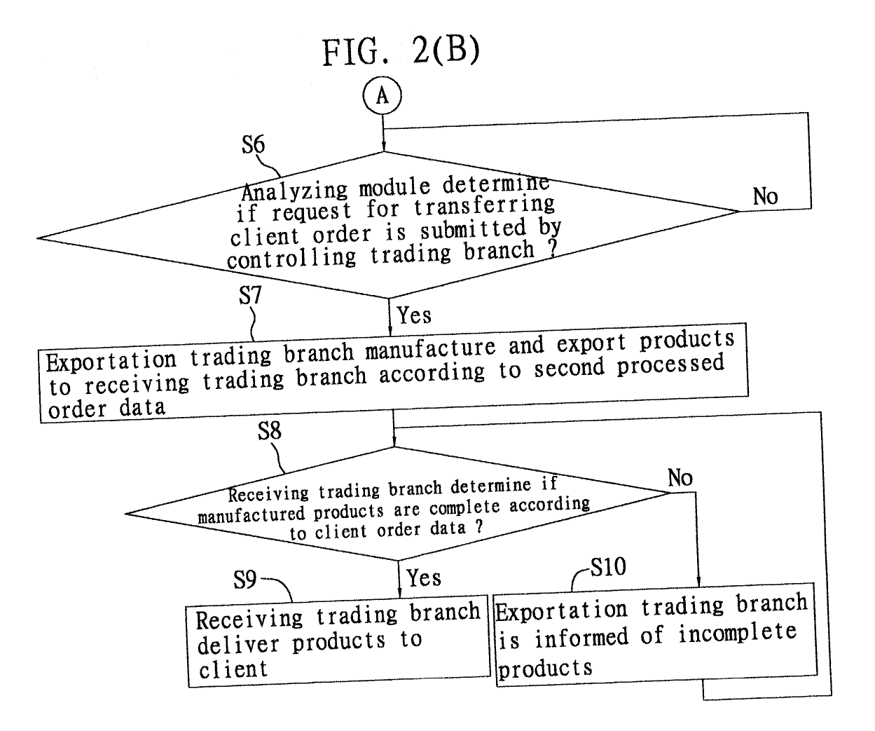

Referring to FIGS. 2(A) and 2(B), they illustrate a preferred embodiment of a method for controlling production and exportation of the invention. The following description is made with reference to FIGS. 1, 2(A) and 2(B) for depicting the method for controlling production and exportation of the invention.

Before trading branches of an enterprise 1 login a system for controlling production and exportation 2, a user is asked to input a user's name and password, allowing the system for controlling production and exportation 2 to provide the user with system authorization according to the inputted user's name and password. Since such an identification procedure is essential for loginning a system via a network, thus it is not further described herein. First in step S1, an analyzing module 21 determines if a request for uploading client order data 200 is submitted by a receiving trading branch 10. If no request is submitted, then the step S1 is returned thereto; or else, step S2 is followed.

In step S2, the analyzing module 21 receives the client order data 200 uploaded by the receiving trading branch 10, and stores the received client order data 200 in an original database 20, whereas the receiving trading branch 10 does not perform product manufacture and exportation at the mean time. Thereafter, step S3 is followed.

In step S3, a processing module 22 is prompted by the analyzing module 21 to retrieve the client order data 200 from the original database 20, and process the retrieved client order data 200 to be first processed order data 230 in a manner that, a material lacking status of the receiving trading branch 10 is marked in the client order data 200, a seller is changed from the receiving trading branch 10 to a controlling trading branch 11, and product prices are adjusted to be lower, wherein the first processed order data 230 are stored in a first database 23. Thereafter, step S4 is followed.

In step S4, the analyzing module 21 determines if a request for transferring a client order is submitted by the controlling trading branch 11. If no request is submitted, the step S4 is returned thereto; or else, step S5 is followed.

In step S5, according to system authorization provided for the controlling trading branch 11, the processing module 22 is prompted by the analyzing module 21 to retrieve the first processed order data 230 from the first database 23, and process the retrieved first processed order data 230 to be second processed order data 240 in a manner that, a material lacking status of the controlling trading branch 11 is marked in the first processed order data 230, a seller is changed from the controlling trading branch 11 to an exportation trading branch 12, and product prices are adjusted to be lower, wherein the second processed order data 240 are stored in a second database 24. Thereafter, step S6 is followed.

In step S6, the analyzing module 21 determines if a request for downloading a client order is submitted by the exportation trading branch 12. If no request is submitted, the step S6 is returned thereto; or else, step S7 is followed.

In step S7, according to system authorization provided for the exportation trading branch 12, the analyzing module 21 retrieves the second processed order data 240 from the second database 24, so as to allow the exportation trading branch 12 to perform product manufacture according to the second processed order data 240. After completing the product manufacture, the exportation trading branch 12 exports manufactured products to the receiving trading branch 10. Thereafter, step S8 is followed.

In step S8, upon receiving the manufactured products from the exportation trading branch 12, the receiving trading branch 10 logins the system for controlling production and exportation 2, and prompts the analyzing module 21 to retrieve the client order data 200 from the original database 20 according to system authorization provided for the receiving trading branch 10. The analyzing module 21 compares the retrieved client order data 200 with the manufactured products, so as to determine if the manufactured products are complete according to the client order data 200. If the products are complete, then step S9 is followed; or else, step S10 is followed.

In step S9, after assuring the completeness of the manufactured products, the receiving trading branch 10 delivers the products to the client.

In step S10, if the receiving trading branch 10 determines the manufactured products are not complete, the exportation trading branch 12 is informed to supplement materials according to the incomplete products. Thereafter, the step S8 is returned thereto.

In the foregoing step S3, the client order data 200 previously received by the receiving trading branch 10 are transferred to the controlling trading branch 11. Therefore, such improved business performance for the controlling trading branch 11 indirectly makes local investors increase their confidence to the controlling trading branch 11. In the subsequent step S5, the controlling trading branch 11 analyzes resource availability of various trading branches, and assigns the exportation trading branch 12 with lower product costs to perform production and exportation. This therefore enhances profits for the enterprise 1.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for controlling production and exportation, used to connect trading branches of an enterprise to a system for controlling production and exportation via a network, wherein the system for controlling production and exportation shares client orders with the trading branches for product exportation, so as to improve business performances for the trading branches, and enhance profits for the enterprise; the method comprising the steps of:
(1) receiving client order data transmitted from a first trading branch via the system for controlling production and exportation, and storing the client order data in an original database of the system for controlling production and exportation, wherein the first trading branch does not perform production and exportation;
(2) retrieving the client order data from the original database via the system for controlling production and exportation, and processing the client order data to be first processed order data in a manner that, a material lacking status of the first trading branch is marked in the client order data, a seller is changed from the first trading branch to a second trading branch, and product prices are adjusted to be lower, wherein the first processed order data are stored in a first database; prompting the second trading branch to login the system for controlling production and exportation, and retrieving the first processed order data from the first database according to system authorization provided for the second trading branch via the system for controlling production and exportation, so as to assign the first processed order data to the second trading branch as a business performance thereof, whereas the second trading branch does not perform production and exportation;
(3) retrieving the first processed order data from the first database via the system for controlling production and exportation, and processing the first processed order data to second processed order data in a manner that, a material lacking status of the second trading branch is marked in the first processed order data, a seller is changed from the second trading branch to a third trading branch, and the product prices are adjusted to be further lower, wherein the second processed order data are stored in a second database; prompting the third trading branch to login the system for controlling production and exportation, and retrieving the second processed order data from the second database according to system authorization provided for the third trading branch via the system for controlling production and exportation, so as to assign the second processed order data to the third trading branch as a business performance thereof, and allow the third trading branch to perform product manufacture; and
(4) exporting manufactured products to the first trading branch via the third trading branch after completing the product manufacture.

2. The method of claim 1, wherein the step (2) further comprises: (2-1) determining via the system for controlling production and exportation if a request for transferring a client order is submitted by the second trading branch, wherein if the request is submitted, the step (3) is followed; or else, the step (2-1) is repeated.

3. The method of claim 1, wherein the step (4) further comprises: loginning the system for controlling production and exportation via the first trading branch after receiving the manufactured products from the third trading branch, and retrieving the client order data from the original database via the system for controlling production and exportation according to system authorization provided for the first trading branch, so as to allow the first trading branch to determine if the manufactured products are complete according to the client order data.

4. The method of claim 1, wherein the second trading branch is like a trading company which does not perform production and exportation.

5. The method of claim 1, wherein the third trading branch has better resources than the second trading branch.

6. The method of claim 5, wherein the resources include human resources.

7. The method of claim 1, wherein the network is internet or intranet.

8. The method of claim 1, wherein the system for controlling production and exportation is established in a server host.

9. A system for controlling production and exportation, connected with trading branches of an enterprise via a network, allowing client orders to be shared with the trading branches for product exportation, so as to improve business performances for the trading branches, and enhance profits for the enterprise; the system comprising:
an original database for storing client order data received by a first trading branch;
an analyzing module for generating corresponding reaction according to requests transmitted from the trading branches;
a processing module for transferring the client order data from the first trading branch to other trading branches, wherein upon receiving a request for uploading the client order data from the first trading branch, the analyzing module stores the uploaded client order data in the original database according to system authorization provided for the first trading branch, and prompts the processing module to retrieve the client order data from the original database, so as to process the client order data to be first processed order data in a manner that, order items of the client order data are reset to be in a material lacking status, product prices are adjusted to be lower than those in the client order data, and a seller is changed from the first trading branch to a second trading branch; wherein subsequently the processing module processes the first processed order data to be second processed order data in a manner that, order items of the first processed order data are reset to be in a material lacking status, product prices are adjusted to be lower than those in the first processed order data, and a seller is changed from the second trading branch to a third trading branch, so as to allow the third trading branch to perform product manufacture and export manufactured products to the first trading branch;
a first database for storing the first processed order data to be retrieved by the second trading branch after loginning the system for controlling production and exportation; and
a second database for storing the second processed order data to be retrieved by the third trading branch after loginning the system for controlling production and exportation.

10. The system of claim 9, wherein after receiving the manufactured products from the third trading branch, the first trading branch logins the system for controlling production and exportation, and the analyzing module is prompted to retrieve the client order data from the original database according to system authorization provided for the first trading branch, so as to allow the first trading branch to determine if the manufactured products are complete according to the client order data.

11. The system of claim 9, wherein the second trading branch is like a trading company which does not perform production and exportation.

12. The system of claim 9, wherein the third trading branch has better resources than the second trading branch.

13. The system of claim 12, wherein the resources include human resources.

14. The system of claim 9, wherein the network is internet or intranet.

15. The system of claim 9, wherein the system for controlling production and exportation is established in a server host.
